(19) United States
(12) Patent Application Publication
(10) Pub. No.: US 2007/0033060 A1
(43) Pub. Date: Feb. 8, 2007

(54) System and method for location assessment

(75) Inventors: Rajan Gopalan, Marietta, GA (US); Kenton Keller, Atlanta, GA (US)

Correspondence Address: ACCENTURE CHICAGO 28164;BRINKS HOFER GILSON & LIONE, P O BOX 10395, CHICAGO, IL, 60610, US

(73) Assignee: Accenture Global Services, GmbH

(21) Appl. No.: 11/196,141

(22) Filed: Aug. 2, 2005

(51) Int. Cl. G06Q 99/00; G06F 9/44; G06F 15/02; G07G 1/00

(52) U.S. Cl. 705/1; 705/7; 705/9; 705/10

(57) ABSTRACT

A system and method for assessing potential outsourcing locations is provided. The system and method decompose the goal of assessing the potential locations into a hierarchy of criteria, such as an analytical hierarchy process model. One example of hierarchy of criteria comprises cost, capability, and risk. The user may input data about the importance of a criterion relative to other criteria. The user may further input data about the potential outsourcing locations, such as cost, capability and risk data for each of the potential locations. Using the data input, the analytical hierarchical process engine may determine weights for each of the criteria and may rank the potential outsourcing locations based on the weighted criteria.

### BACKGROUND

1. Field of the Invention

The present invention relates generally to a system and method for assessing locations, and more particularly to a system and method for evaluating potential offshore locations to support the maintenance and development of applications as part of an outsourcing arrangement.

2. Related Art

Outsourcing is a process in which a company delegates some of its in-house goods, operations, and/or processes to a third party. Outsourcing may be applied to many types of goods, operations, or processes. For example, outsourcing may be used for any or all of a company's Information Technology (IT) and IT-enabled tasks, products and services. Examples of IT outsourcing may include, but are not limited to: planning and business analysis; installation, management, and servicing of the network and workstations; web solutions; web development; web design; website security; website maintenance; web hosting e-commerce (e.g., business-to-business, business-to-customer, and customer-to-business); transaction management, etc. As another example, outsourcing may be used for business process management tasks, including, but not limited to: electronic customer relationship management; supply chain management; back office; payroll; billing; accounting; telemarketing and call centers; teleservice and product support, etc.

Companies may choose to outsource for a variety of reasons. Reasons may include, but are not limited to, one or more of the following: if handling too many non-core operations results in the company losing focus on its core business; if the company is facing a time, money, and/or human resource dilemma; if the company has a mission-critical project that needs significant time and energy resources from the company, and specialized skills to perform which are not readily available; and if it is important to be the first into the market to gain an edge over competitors. Through outsourcing, the company may achieve one or more of the following goals including: (1) lower cost; (2) faster development and startup; (3) technical and/or functional advantage over the company's competition; (4) enhanced performance; (5) reliability; (6) security; (7) maximizes uptime; and (8) potentially more effective operating environment on the backend.

After a company decides to outsource, the next inquiry is where to outsource. Currently, many companies simply choose Bangalore, India as the location for outsourcing given the number of companies that have already outsourced there and given its reputation as India's Silicon Valley. However, there are dozens of other locations in which a company may outsource in every continent of the planet, ranging from a location as close as the same city or country as the company, to a location that is half way around the world from the company. For example, there are locations in the Far East (such as cities other than Bangalore in India, China, Philippines, Vietnam), Latin America, Europe (such as the UK, Spain); Eastern Europe (such as the Czech Republic), Africa (such as Mauritius), and North America (United States, Canada, Mexico).

Given a company's goals for outsourcing and the strengths/weaknesses of potential outsourcing locations, a company may wish to analyze the potential locations to determine which potential location best meets the goals of the outsourcing, rather than relying on the conventional wisdom to outsource in Bangalore, India. However, this analysis can be difficult. If a company attempts to compare potential outsourcing locations, most often the analysis is intuitive with little rigorous analysis. If a company attempts to analyze the potential locations more quantitatively, the company may rely on traditional decision making; however, this type of decision making may fail to assess potential outsourcing locations effectively. Thus, there is a need to better analyze potential locations for outsourcing.

### BRIEF SUMMARY

The invention provides a system and method for evaluating potential outsourcing locations using an Analytical Hierarchical Process (AHP). AHP may decompose the goal of evaluating the potential outsourcing locations into a hierarchy of criteria. One example of the hierarchy of criteria comprises cost, capability, and risk criteria, each with sub-criteria. The user may input data regarding the importance of the criteria relative to other criteria. For example, the user may input how important cost is relative to capability and relative to risk. The user may also input data about the potential outsourcing locations. For example, the user may enter data regarding the costs associated with outsourcing in the potential outsourcing locations, the capability of the labor force in the potential outsourcing locations, and the risk associated with outsourcing in the potential outsourcing locations. The data may comprise raw data (such as, for example, percentage inflation rates) with a measurement scale (such as, for example, translating ranges of inflation rates into “low,” “medium,” or “high” inflation rates). Further, weights may be assigned to the measurement scale. For example, weights may be assigned to inflation rates for “low,” “medium,” or “high” inflation rates. The weights may be non-linear and, when graphed, may form an elbow.

Using data provided from the user, AHP may perform a pair-wise comparison of the criteria, comparing each of the criteria with other criteria, to determine weights for the criteria. Further, AHP may rank the potential outsourcing locations based on the weighted criteria and based on the input data about the potential outsourcing locations. The ranking of the potential outsourcing locations may be used to select a site to outsource. Or, the process may be iterated. For example, the weights for the criteria and/or the weights for the measurement scale may be modified, and the potential outsourcing locations may be ranked again.

### BRIEF DESCRIPTION OF THE DRAWINGS

FIG. 1 is a flow diagram of one configuration of the invention using AHP.

FIG. 2 is a table of potential locations and a shortlist of locations generated in block 120 in FIG. 1.

FIG. 3 is a diagram of one hierarchy of criteria for use with AHP.

FIG. 4 is a diagram of another hierarch of criteria for use with AHP and with associated weights.

FIG. 5 is a table of exemplary output for AHP using the criteria shown in FIG. 3.

FIG. 6 is a block diagram of one example of a processing system to perform AHP.

### DETAILED DESCRIPTION OF THE DRAWINGS AND THE PRESENTLY PREFERRED EMBODIMENTS

By way of overview, the preferred embodiments described below relate to a method and system for assessing potential locations for outsourcing. The method and system described herein may be used to assess a first-time location for outsourcing. For example, a company may use the present invention to assess potential outsourcing locations when first outsourcing either IT or business process management tasks. Or, the method and system may be used to assess a second outsourcing location, which may be used in addition to an existing outsourcing site. For example, if a company already has an outsourcing location in Bangalore, India, rather than simply expanding the Bangalore facility, a company may assess potential outsourcing locations, in addition to expanding the Bangalore facility, in order to better determine which location is best for outsourcing.

Quantitatively assessing potential outsourcing locations based on the goals of the outsourcing in a meaningful way is difficult. First, there are typically multiple goals for an outsourcing project that are intricately interrelated. Second, the potential outsourcing locations typically have markedly different strengths and weaknesses.

Given these difficulties, traditional decision making, typically used when attempting to assess potential outsourcing locations, fails to assess potential outsourcing locations effectively. Traditional decision making forces comparisons among criteria that are often expressed in very different terms. For example, traditional decision making may include establishing criteria for making a decision, and then placing each criterion in a column and evaluating each potential location for each criterion. However, there are several problems in using this traditional methodology including: the criterion rating scales are different; the importance of the criteria is not accounted for; the result of the comparison does not include all criteria; and judgments are made using an ordinal scale, typically a simple 1(Poor)-2(Good)-3(Best) rank ordering, the results of which should not be added.

Instead of using traditional decision making, one aspect of the invention uses the Analytic Hierarchy Process (AHP). AHP is a powerful and flexible decision-making tool when both qualitative and quantitative aspects of a decision should be considered. It is based on the assumption that when faced with a complex decision, the natural human reaction is to cluster the decision elements according to their common characteristics. AHP reduces complex decisions to a series of pair-wise comparisons, and then synthesizes the results, thereby assisting decision-makers to arrive at the best decision using a clear rationale. AHP may include using an AHP engine, which may include software, hardware, or a combination of software and hardware, to execute the series of pair-wise comparisons and synthesize the results. Specifically, AHP may involve building a hierarchy of decision elements, such as an AHP model, and then, using an AHP engine, making comparisons between each possible pair in each cluster.

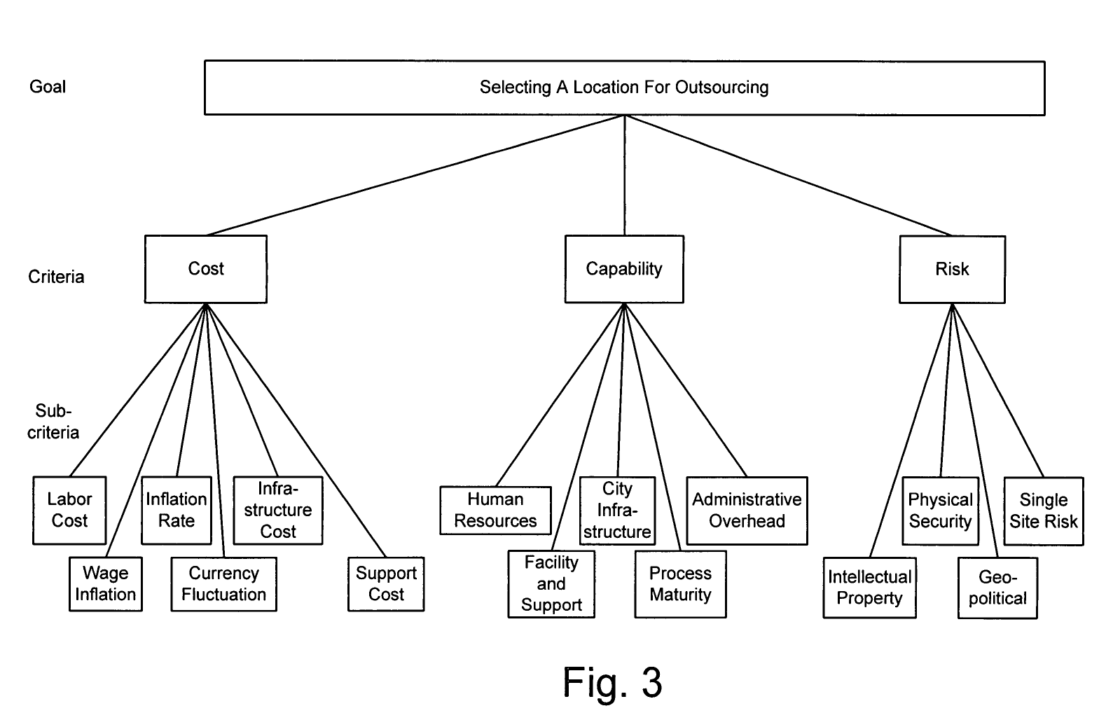

As discussed in more detail below, the first step in AHP may be to decompose the goal (in this case, selecting a potential outsourcing location) into its constituent parts, progressing from the general to the specific. In its simplest form, this structure may be an AHP model and comprise a goal, criteria, sub-criteria, etc. Each set of criteria may then be further divided into an appropriate level of detail, recognizing that the more criteria included, the less important each individual criterion may become. This first step is discussed in more detail with respect to FIG. 3.

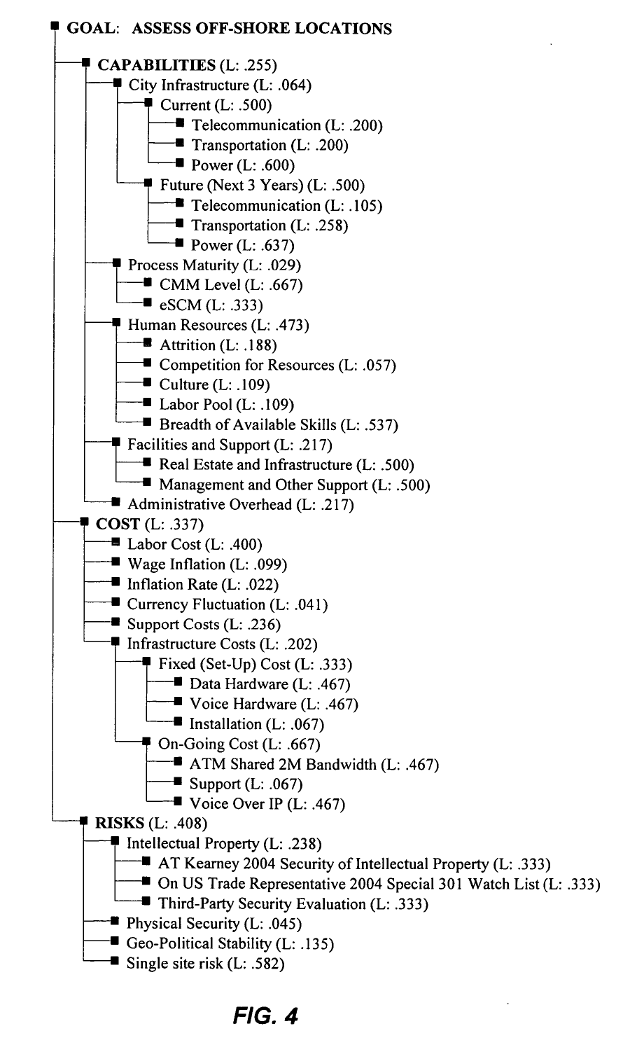

The next step in AHP may be to assign a relative weight to each criterion. Each criterion may have a local (or immediate) priority and global priority. The weights may be assigned to the criteria in a variety of manners, such as from the lowest level to the highest level of the hierarchy, or from the highest level to the lowest level of the hierarchy. As discussed in more detail in FIG. 4, the sum of all the criteria beneath a given parent criterion in each tier of the model must equal one. Its global priority shows its relative importance within the overall model.

Finally, after the criteria are weighted, using an AHP engine, the potential locations may be subjected to pair-wise comparison with one another based on the criteria. This pair-wise comparison of the potential locations may be performed in a variety of ways. As merely one example, the comparison between the potential locations may be performed indirectly. Rather than comparing one potential location with another, each potential location may be evaluated according to a defined measurement scale. Specifically, information for the potential locations may be collected relating to the criteria, scored, and the scoring system may be provided with various weights. As discussed in more detail below, labor cost may be one of the sub-criteria for cost. The labor cost information for each of the potential locations may be gathered, and an assessment of the labor cost information (such as very low, low, high, or very high) may be assigned to the data. The assessment of the cost information may be given weights, such as 1.000 for very low, 0.850 for low, 0.170 for high, and 0.074 for very high. In this way, the labor cost sub-criteria for the various locations are compared indirectly. Further, scoring of the criteria for the locations may be accomplished in a variety of ways. For example, relative scores for each choice may be computed within each leaf of the hierarchy. Scores may then be synthesized through the model, yielding a composite score for each choice at every tier, as well as an overall score. As another example, the comparison between potential locations may be performed directly. In the labor cost example, each of the potential locations may be compared directly with one another, such as comparing the labor cost of Bangalore, India with Toronto, Canada, and determining that the labor cost in Bangalore is 3 times better than the labor cost in Toronto. Using either the direct or indirect comparison, scoring may be on a relative basis, not an absolute basis, in order to compare one choice to another.

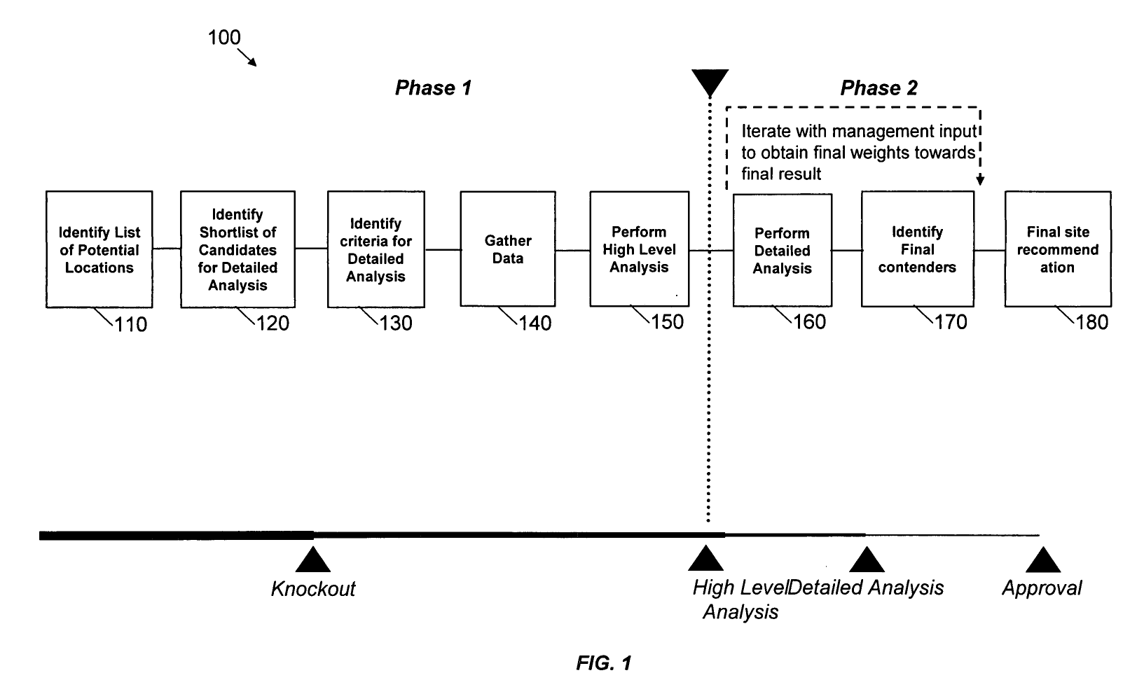

Turning to the drawings, wherein like reference numerals refer to like elements, FIG. 1 shows a flow chart 100 of one methodology for assessing potential outsourcing locations. The flow chart 100 may be segmented into two phases, with a first phase involving a high-level analysis and a second phase involving a detailed analysis. As discussed in more detail below, the high-level analysis may perform functions in preparation for the detailed analysis of potential outsourcing locations. The functions in phase one may include identifying the list of potential outsourcing locations 110, reducing the potential outsourcing locations to a shortlist 120, identifying criteria for the detailed analysis in phase two 130, gathering data 140, and performing a high-level analysis of the data 150. The detailed analysis is performed in phase two to quantitatively assess the locations on the shortlist. As discussed in more detail below, the functions in phase two may include performing detailed analysis 160, identifying final contenders 170, and making a final site recommendation 180.

As shown in block 110 of FIG. 1, a list of potential locations for outsourcing may be compiled. The list may be based on a variety of sources including, without limitation: industry trends; input from the company seeking to outsource; or input from any third party. The list may be a partial list of potential outsourcing locations, such as representative locations in a single continent or multiple continents. Or, the list may be a complete list of potential outsourcing locations in a single continent or multiple continents.

FIG. 1 shows at block 120 that a shortlist of potential locations for subsequent detailed analysis may be generated. The shortlist may be based on the list of potential locations generated in step 110. In order to simplify the detailed analysis discussed subsequently, the number of potential locations may be reduced by applying basic criteria to remove clearly infeasible locations. However, reducing the number of potential locations to a shortlist is not required to be performed; instead, the detailed analysis may be performed on each of the potential locations generated in step 110.

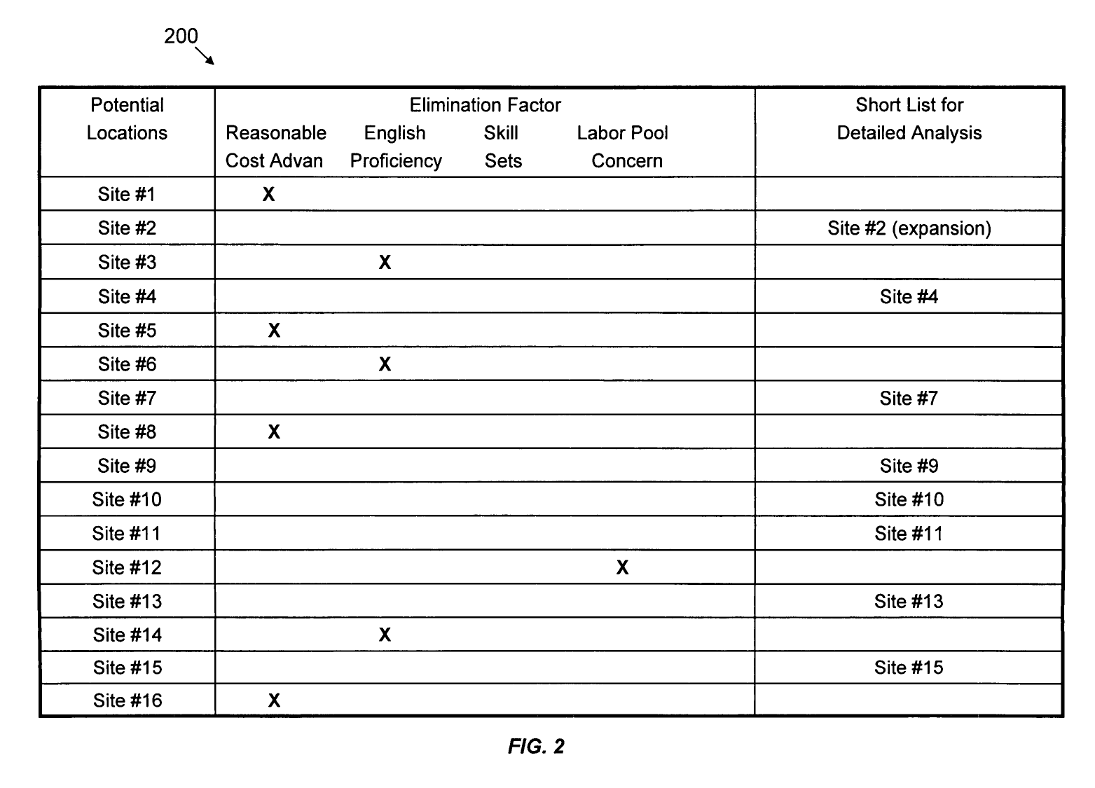

Any one or more criteria may be used to generate the shortlist of potential locations. The criteria may be characterized as “knock-out” criteria, whereby if a potential location has this criterion, it may be immediately eliminated from additional analysis. FIG. 2 shows a table 200 of one example of the criteria used to generate the shortlist. There are 16 potential locations listed, as shown in FIG. 2. More or fewer locations may be used. Each of the potential locations may be assessed for any one of the elimination factors. First, the potential locations may be assessed for whether there is a reasonable cost advantage to outsourcing at the location. As shown in FIG. 2, four of the sites do not provide a reasonable cost advantage and therefore are eliminated from the shortlist. Second, the potential locations may be assessed to determine whether the labor pool has sufficient English proficiency. Third, the potential locations may be assessed to determine whether the labor pool has sufficient skill sets for performing the outsourcing tasks. Fourth, the potential locations may be assessed to determine whether the labor pool has sufficient depth. As shown in FIG. 2, four elimination factors are used. However, more, fewer, or different elimination factors may be used.

As shown in block 130 of FIG. 1, criteria for the detailed analysis are identified. The criteria may be based on input from the company seeking to outsource or input from any third party. Moreover, the criteria may be static from one assessment of potential outsourcing locations to the next, or may be dynamic, with one, some or all of the criteria changing each time potential locations are assessed. Further, identifying the criteria for the detailed analysis may be performed at any time prior to the detailed analysis. If the criteria are static from one assessment to the next, determining the criteria may be performed once and not repeated. If the criteria are dynamic, identifying the criteria may be determined as shown in FIG. 1, or may be determined prior to blocks 110 or 120.

Further, the criteria may be arranged in a hierarchy, which describes the relationship between the criteria. One example of the hierarchy of criteria is shown in FIG. 3. The stated goal is shown, below which are various levels of criteria. The first level may comprise criteria, the second level may comprise sub-criteria, the third level of criteria may comprise sub-sub-criteria, etc. FIG. 3 shows a two-level hierarchy; however, more or fewer levels may be used. Another example of a hierarchy is shown in Table 1 and FIG. 4, both discussed below. FIG. 4 shows a five level hierarchy.

The goal of the detailed analysis, as shown in FIGS. 3 and 4, is selecting a location for outsourcing. The first level of the hierarchy may include three criteria: cost; capability; and risk. Cost generally relates to the costs involved in setting up and/or operating an outsourcing operation. Capabilities generally relates to the capabilities of the labor pool, specific site, or specific city/state of the potential location. Risk generally relates to the risks involved in outsourcing to a potential location.

FIG. 3 and Table 1, shown below, include a listing of exemplary criteria for the second level of the hierarchy and descriptions of the criteria in the second level. Table 1 also includes measurement scales for the sub-objectives and priority information, both described in more detail below. As shown in FIG. 3 and Table 1, sub-criteria of the cost criterion may include: labor costs; wage inflation; inflation rate; currency fluctuation; support costs; and infrastructure costs. As discussed above, the sub-criteria may likewise have sub-sub-criteria, with the infrastructure costs sub-criteria including sub-sub-criteria of fixed (set-up) costs and ongoing costs. Moreover, sub-criteria of the capabilities criterion may include: human resources; facilities and support; city infrastructure; process maturity; and administrative overhead. The sub-criteria of the risk criterion may include: intellectual property; physical security; geo-political risk; and single site risk. More, fewer, or different sub-criteria for the cost, capabilities, and risk criteria may be used.

TABLE 1

| | | | |
|---|---|---|---|
| Criteria | Description | Measurement Scale | Priority |

Cost

| | | | |
|---|---|---|---|
| Labor Costs | Labor Cost mapped using | Very Low | 1.000 |
| | Cost of Living indices. | Low | .850 |
| | | High | .170 |
| | | Very High | .074 |
| Wage Inflation | Amount of wage inflation in | Low | 1.000 |
| | each country for the IT | Medium | .550 |
| | workforce. | High | .303 |
| Inflation Rate | Country inflation rate. | <5% = Low | 1.000 |
| | | 5-10% = Medium | .247 |
| | | >10% = High | .101 |
| Currency | Exchange rate trend and | Excellent (>8 points) | 1.000 |
| Fluctuation | stability of the currency | Very Good (7-8 points) | .510 |
| | against the US Dollar: | | |
| | a) Average rate fluctuation | Good (5-6 points) | .252 |
| | last 5 years (8 points if 0-5%, | Fair (3-4 points) | .124 |
| | 6 points if 5-10%, 4 points in | Poor (<2 points) | .065 |
| | 10-15%, 0 points if > 15%) | | |
| | b) Trend for last 5 years (1 | | |
| | point if $ appreciating, 0 | | |
| | points if $ depreciating) | | |
| Support Costs | Increase in management | None (0) | 1.000 |
| | overhead for supporting | Very Low (1) | 1.000 |
| | additional off-shore location | Low (2) | .500 |
| | due to: | High (3) | .170 |
| | a) Lack of mgmt | Very High (4 or 5) | .074 |
| | Leveragability | | |
| | b) Additional Time Zone | | |
| | Coordination | | |
| | c) Additional Oversight | | |
| | d) Additional effort spent | | |
| | adapting to multiple | | |
| | cultures | | |
| | e) Travel overhead (with | | |
| | increased distance from | | |
| | original outsource site) | | |
| Infrastructure Costs | | | |
| a) Fixed (Set-up | One-time setup costs for data | | |
| Costs) | and voice network | | |
| (i) Data Hardware | Routers, firewalls, cabling, | Low (<$250k) | 1.000 |
| | etc. | Medium ($250k to $500k) | .402 |
| | | High($500k-$1M) | .153 |
| | | No Plans | .064 |
| (ii) Voice | Switch, PBX, cabling, etc. | Direct Dial | 1.000 |
| Hardware | | Low (<$500k) | 1.000 |
| | | Medium ($500k-$1M) | .384 |
| | | High (>$1M) | .169 |
| | | No Plans | .071 |
| (iii) Installation | Expense to install the | Low (=<$100k) | 1.000 |
| | hardware (incl. labor) | Medium ($100k-$250k) | .329 |
| | | High (>$250k) | .108 |
| b) On-going Costs | Recurring costs for data and | | |
| | voice services | | |
| (i) ATM | Circuit costs for 2M | Low (<$5K) | 1.000 |
| (Asynchronous | bandwidth per month | Medium ($5K-$10K) | .329 |
| Transfer Mode) | | | |
| Shared 2M Bandwidth | | High (>$10K) | .108 |
| (ii) Support | Hardware and other support | Low | 1.000 |
| | costs. No absolute basis for | Comparable | .329 |
| | this - comparing to current | High | .108 |
| | costs for work in original | | |
| | outsource site. | | |
| (iii) Voice Over IP | Circuit costs for supporting | Low | 1.000 |
| (Internet Protocol) | 500 resources per month. | Comparable | .329 |
| | | High | .108 |

Capabilities

| | | | |
|---|---|---|---|
| City Infrastructure | | | |
| a) Current | | | |
| (i) Telecom. | a) Landline easy to get | Excellent (all 5) | 1.000 |
| | b) Cell phone easy to get | Good (any 4) | .497 |
| | c) DSL available | Fair (2 or 3) | .146 |
| | d) Internet easily available | Poor (1 or 0) | .073 |
| | e) Commercial data services | | |
| | available | | |
| (ii) Transportation | a) Adequate Highways | Excellent (all) | 1.000 |
| | b) Adequate Mass Transit | Good (any 3) | .427 |
| | c) Reasonable traffic | Fair (any 2) | .132 |
| | congestion | Poor (1 or 0) | .067 |
| | d) Good road conditions | | |
| (iii) Power | Power outages that may | Stable | 1.000 |
| | interrupt work | Some Power Outage | .430 |
| | | Frequent Power Outage | .111 |
| b) Future (next 3 | | | |
| years) | | | |
| (i) Telecom. | a) Landline easy to obtain | Excellent (all 5) | 1.000 |
| | b) Cell phone easy to get | Good (any 4) | .497 |
| | c) DSL (Digital Subscriber | Fair (2 or 3) | .146 |
| | Line) available | Poor (1 or 0) | .073 |
| | d) Internet easily available | | |
| | e) Commercial data services | | |
| | available | | |
| (ii) Transportation | a) Adequate Highways | Excellent (all) | 1.000 |
| | b) Adequate Mass Transit | Good (any 3) | .427 |
| | c) Reasonable traffic | Fair (any 2) | .132 |
| | congestion | Poor (1 or 0) | .067 |
| | d) Good road conditions | | |
| (iii) Power | Power outages that may | Stable | 1.000 |
| | interrupt work | Some Power Outage | .430 |
| | | Frequent Power Outage | .111 |
| Process Maturity | | | |
| a) CMM (Capability | CMM Assessment Level | CMM Level 5 | 1.000 |
| Maturity Model) Level | | CMM Level 4 | 1.000 |
| | | CMM Level 3 | .317 |
| | | CMM Level 2 | .095 |
| | | CMM Level 1 | .095 |
| b) eSCM | extended Sourcing | Level 3, 4, 5 | 1.000 |
| | Capability Model (eSCM) | Level 2 | .320 |
| | for Outsourcing. | Level 1 | .154 |
| | | Not Assessed | .063 |
| Human Resources | | | |
| a) Attrition | Employee turnover; | <5% = Excellent | 1.000 |
| | increases cost and risk of | ≧5% and <10% = Good | .478 |
| | missing SLAs | | |
| | | ≧10% and <15% = Fair | .181 |
| | | ≧15% and <20% = Poor | .097 |
| | | ≧20% = Unacceptable | .056 |
| b) Competition for | Level of competition in the | Weak | 1.000 |
| Resources | city for skilled IT resources | Moderate | .309 |
| | | Strong | .157 |
| | | Intense | .066 |
| c) Culture | a) Language | Consistent (4 or 5) | 1.000 |
| | b) Work ethic | Compatible (2 or 3) | .189 |
| | c) Willingness to do | Inconsistent (1 or 0) | .084 |
| | maintenance work and | | |
| | work shifts | | |
| | d) Effort to assimilate and | | |
| | train | | |
| | e) Adaptability to the U.S. | | |
| d) Labor Pool | Labor pool projections for | High | 1.000 |
| | the cities in terms of | Medium | .231 |
| | available experienced | Low | .080 |
| | resources and access to | | |
| | graduates from educational | | |
| | institutions; considers | | |
| | possible tightening of, or | | |
| | increase in labor pool | | |
| | availability for a city in | | |
| | the future. | | |
| e) Breadth of | Resources have the | 100% = Excellent | 1.000 |
| Available Skills | following skill sets: | 90% = Good | .366 |
| | 1) Mainframe COBOL | 80% = Acceptable | .232 |
| | 2) JAVA J2EE | 70% = Poor | .119 |
| | 3) UNIX C++ | <70% = Unacceptable | .048 |
| | 4) UNIX Shell Scripting for | | |
| | ESS and PSS | | |
| | 5) Peoplesoft HRMS, Oracle | | |
| | Financials | | |
| | 6) Siebel | | |
| | 7) EI/Middleware | | |
| | 8) DB/Data Warehousing | | |
| | 9) Microsoft ® Technologies | | |
| | (VB, PB, ASP.NET, etc.) | | |
| | 10) Testing | | |
| Facilities and | Scalability of existing | | |
| Support | location to accommodate | | |
| | growth | | |
| a) Real Estate and | 1) Can accommodate 500 | Highly Scaleable | 1.000 |
| Infrastructure | FTEs | Somewhat scaleable | .274 |
| | 2) Available in a timely | Not likely to scale | .184 |
| | manner | Unavailable | .063 |
| | 3) Growth area - includes | | |
| | building, space, office | | |
| | equipment, and furniture. | | |
| b) Management and | 1) Can accommodate 500 | Highly Scaleable | 1.000 |
| Other Support | FTEs | Somewhat scaleable | .274 |
| | 2) Available in a timely | Not likely to scale | .184 |
| | manner | Unavailable | .063 |
| | 3) Growth area - ability to | | |
| | support growth - HR, | | |
| | management, technology, | | |
| | admin, facility | | |
| Administrative | Administrative and | No overhead | 1.000 |
| Overhead | management overhead to | Limited overhead | .525 |
| | manage and coordinate a | Sizeable overhead | .210 |
| | second location in addition to | Large overhead | .087 |
| | original outsource site. The | | |
| | overhead is due to the | | |
| | difference in culture, time | | |
| | zone, working style, | | |
| | management structures and | | |
| | organization, travel | | |
| | coordination, etc. | | |

Risk

| | | | |
|---|---|---|---|
| Intellectual Property | | | |
| a) A T Kearney 2004 | As compared to 25 countries | High | 1.000 |
| Security of Intellectual | | Medium | .550 |
| Property | | Low | .303 |
| b) On US Trade | Priority Foreign Country: those | Not on any | 1.000 |
| Representative 2004 | pursuing the most onerous or | 301 Watch List | .253 |
| Special 301 Watch List | egregious policies that have | 301 Priority Watch List | .149 |
| | the greatest adverse impact | | |
| | on U.S. right holders or | Priority Foreign Country | .067 |
| | products, and are subject to | | |
| | accelerated investigations | | |
| | and possible sanctions 301 | | |
| | Priority Watch List: do | | |
| | not provide an adequate | | |
| | level of IPR protection or | | |
| | enforcement, or market | | |
| | access for persons relying | | |
| | on intellectual property | | |
| | protection 301 Watch List: | | |
| | merit bilateral attention | | |
| | to address underlying IPR | | |
| | problems. Section 306 Monitor: | | |
| | to address specific problems | | |
| | raised in earlier reports. | | |
| c) Third Party Security | Ratings are based on | Excellent | 1.000 |
| Evaluation | information received from | Very Good | .577 |
| | third party | Good | .325 |
| | | Fair | .129 |
| | | Poor | .079 |
| Physical Security | Building access, security | High | 1.000 |
| | guards. | Medium | .329 |
| | | Low | .108 |
| Geo-Political | Based on AT Kearney report. | High | 1.000 |
| Stability | “Country risk” as compared | Medium | .550 |
| | to 25 countries. Includes | Low | .303 |
| | overall business and political | | |
| | environment, AT Kearney | | |
| | Foreign Direct Investment | | |
| | Confidence Index, extent of | | |
| | bureaucracy, and | | |
| | government support for the | | |
| | information and | | |
| | communications technology | | |
| | sector. | | |
| Single site risk | Risk of remaining in original | Risk applies | 1.000 |
| | outsource site as the only | Risk does not apply | .250 |
| | off-shore location: | | |
| | a) Business continuity risk | | |
| | b) Geo-political risk | | |
| | c) Tightening of labor pool | | |
| | d) Worsening of the city | | |
| | infrastructure | | |

One example of the criteria described in the table above includes eSCM (extended Sourcing Capability Model). The capability levels of the eSCM may describe an improvement path that clients should expect service providers to travel. This path may start from a desire to provide IT-enabled sourcing services, and may continue to the highest level, demonstrating an ability to sustain excellence. The five capability levels in this improvement path may include: (1) providing services; (2) consistently meeting requirements; (3) managing organizational performance; (4) proactively enhancing value; and (5) sustaining excellence.

With regard to the Level 1, the capability of service providers may vary widely. These providers may very likely be a high risk to work with because they often promise more than they deliver. Service providers at Capability Level 2 may have formalized procedures for capturing requirements and delivering the services according to commitments made to clients and other stakeholders. Providers may be able to deliver specific services according to stated client expectations, provided the services do not significantly vary from the provider's experiences. At Level 2, the service provider may be able to systematically capture and understand requirements, design and deploy services to meet the requirements, and successfully deliver the services according to agreed upon service levels. The infrastructure-work environment, training, technology, information, etc.—may be in place to support consistent performance of work that meets the service provider's commitments.

With regard to Level 3, service providers may be capable of delivering services according to stated requirements, even if the required services differ significantly from the provider's experience. At Level 3, the service provider may be able to manage its performance across the organization; proactively understand targeted market services and their varying requirements, including specific cultural attributes; identify and manage risks across engagements; and design and deliver services based on established procedures. The service provider may support this capability through sharing and using knowledge gained from previous engagements, objectively measuring and rewarding personnel performance, and monitoring and controlling technology infrastructure.

With regard to Level 4, service providers may be able to continuously enhance their capability to meet evolving requirements. At Level 4, the service provider may be able to customize its approach and service for clients and prospective clients, understand client perceptions, and predict its performance based on previous experiences. The service provider supports this capability through leveraging professional development and workforce competencies in achieving organizational objectives, systematically evaluating and incorporating technology advances, and setting performance goals from a comparative analysis of its current performance as well as from internal and external benchmarks. Level 4 providers may systematically plan, implement, and control their own improvement, typically generating these plans from their own performance benchmarks. They may continuously innovate to add statistically and practically significant value to the services they provide to their clients and other stakeholders.

With regard to Level 5, service providers may have demonstrated measurable, sustained, and consistent performance excellence and improvement by effectively implementing all of the Level 2, 3, and 4 practices for two or more consecutive Certification Evaluations covering a period of at least two years.

After the criteria are identified, the pair-wise comparison may be performed using an AHP engine. As discussed above, the criteria for the AHP analysis may comprise various levels of a hierarchy. For every level of the hierarchy, each criterion may be compared to another criterion, and assigned a weight relative to the other criterion. These comparisons may be referred to as pair-wise comparisons. By reducing complex decisions to a series of pair-wise comparisons and then synthesizing the results, decision-makers may arrive at a better decision based on a clear rationale. AHP also provides a way to evaluate how decision changes can affect an outcome and measures how well the decision maker understands the relationships among the factors.

One of the reasons to use the AHP is its ability to provide reliable and accurate ratio-scale priorities for a set of elements. Ratio-scale priorities are especially valuable when making a series of decisions in which the priorities are carried forward and used as a basis for each new decision. Simple ranking of priorities results in far less precision than ratio scale priorities, which indicate exactly how much more important one element is than another. Knowing whether element “A” is 3% more important, 50% more important or 10 times more important than B, C, or D is much more valuable than knowing simply that it is more important.

AHP may organize factors into a tree structure, which represents the innate model of operation of human mind, and may help complex decisions by decomposing the problem into criteria, such as factors. AHP may also help to determine the factor weights, and may be especially useful when it is difficult to determine factor weights (numbers) directly. AHP may derive weights by comparing the relative importance between two factors, called pair-wise comparison.

One system for implementing an outsourcing location assessment using AHP may be based on the Expert Choice 11 software package from Expert Choice, Incorporated, Arlington, Va. The Expert Choice 11 software package may be used to collect data and calculate results incorporating AHP as outlined by Thomas Saaty. See Thomas Saaty, The Analytical Hierarchy Process, McGraw-Hill (1980), which is incorporated herein by reference in its entirety.

Another system for implementing an outsourcing location assessment using AHP may be based on a mathematics program, such as Matlab®, and a spreadsheet program, such as Excel®. Matlab® may take the reciprocal matrix and raise it to arbitrarily large powers and dividing the sum of each row by the sum of the elements to obtain the eigenvalues. For example, Matlab® may raise each individual matrix to an arbitrary power. The powers of the matrices may be raised until the desired accuracy in the eigenvalues is achieved. The breaking point to which all the individual matrices start to produce the required accuracy of three places to the right of the decimal point may be at the power of ten or less. Next, Excel® may be used to sum each row and all the individual numbers in each matrix. Then, the sum of each row may be divided by the total sum of the elements of each matrix and tabulated the results.

Using Matlab®, AHP parameters may be calculated. For example, the aggregated weights from individual pair-wise comparisons may be calculated. To obtain the aggregated weights from the individual pair-wise comparisons, the geometric mean may be calculated of the input to each pair-wise comparison. This may be performed by multiplying the numerical values of the inputs together and taking the mth root of the product where m is the number that are providing input. A reciprocal matrix may be constructed using the aggregated pair-wise comparisons and determine the weightings as the eigenvalues of the matrix.

One can approximate the eigenvalues of the matrix by hand calculation to the precision desired. However, the calculation may be considerably expedited using Matlab® software to conduct the matrix algebra. In either case, one can raise the matrix to an arbitrary power, and normalize the sum of the rows to approximate the eigenvalues. Accuracy increases as the power to which the matrix is raised increases.

The aggregated weight of each pair-wise comparison may comprise the geometric mean of the individual comparisons. The reciprocal matrix of the aggregated pair-wise comparisons yields the relative weights for each criterion. For this matrix, eigenvalues may be approximated to greater than three decimal point accuracy with the reciprocal matrix raised to a power greater than four.

As another example, the individual scores may be calculated. To calculate the individual weighting of criteria, the reciprocal matrix may be formed based on the pair-wise comparisons and the individual weightings are determined as the eigenvalues of the matrix. From the individual weighting, the total score may be calculated by summing the products.

FIG. 1 shows one example application of AHP. Data may be gathered based on the criteria, as shown at block 140. The data may be gathered for the potential outsourcing locations on the shortlist if a shortlist of potential outsourcing locations is used (see block 120). Or, the data may be gathered for all of the potential outsourcing locations. The data may be compiled based on a variety of sources, including public information, analyst reports, site visits to the potential locations, and interviews.

After the data is gathered, the data may be analyzed on a high level, as shown at block 150. The analysis may be based on the identified criteria and on a high level measurement scale. For example, one of the sub-criteria for cost is inflation rate. As shown in Table 1, the inflation rate may be given a measurement scale of “Low” for an inflation rate less than 5%, “Medium” for an inflation rate between 5% and 10%, and “High” for an inflation rate above 10%. The measurement scale is provided merely as an example. Inflation rate data for one, some, or all of the potential outsourcing sites may be gathered in block 140. The gathered inflation rate data may then be rated at a high level based on the measurement scale in block 150. For example, a potential site with an inflation rate of 7% may be designated as having a “Medium” inflation rate. Further, the high-level analysis of the gathered data may be used as a check for data inconsistencies.

As shown at block 160, a detailed analysis may be performed. The detailed analysis may comprise assigning weights to the measurement scales, assigning weights to the criteria, and then scoring the potential locations for the criteria based on the assigned weights. For example, the inflation rate sub-criteria includes a measurement scale of “Low,” “Medium,” and “High.” As shown in Table 1 above, weights may be assigned to the measurement scale, such as 1.000 for a “Low” inflation rate, as 0.247 for a “Medium” inflation rate, and as 0.101 for a “High” inflation rate. Weights may thus be assigned to one, some or all of the measurement scales. As shown in Table 1, a variety of weights for the measurement scale may be selected. For example, the weights may be weighted very heavily toward one side of the measurement scale. The assigned weights may be non-linear and may follow any curve, including exponential, geometric, or the like. In the example discussed above, the weight for the “Low” inflation rate is 4 times the weight for the “Medium” inflation rate and nearly 10 times the weight for the “High” inflation rate.

Further, weights may be assigned to the criteria. FIG. 4 shows one example of a hierarchy, with weights shown in parentheses. The weights provide the relative importance between two criteria, called pair-wise comparison. Deriving the weights may be accomplished in a variety of ways. For example, the operator may answer questions relating to the relative importance of various criteria. The questions may request a comparison of one criterion to another, such as one criterion is equally important, moderately more important, strongly more important, very strongly more important, or extremely more important. Based on the answers to the questions, a software program may calculate the weights. In addition, the operator may review the weights calculated by the software program, and may modify them based on the operator's expertise.

The weights provided in FIG. 4 are merely for purposes of example. FIG. 4 shows 4 levels of criteria, with Cost, Capability, and Risk being at the highest level. The weights at each level add up to 1, which shows the relative importance of each criterion. As shown in FIG. 4, the weights for “Cost,” “Capability,” and “Risk” are 0.255, 0.337 and 0.408, respectively. This weighting indicates that Risk is the most important criterion at the highest level and is 1.6 times more important that “Cost”. Within each criterion, there may be sub-criteria and sub-sub-criteria which have weights that also follow the same rules. For example, under the “Cost” criterion, weights for the sub-criteria of “labor cost,” “wage inflation,” “inflation rate,” “currency inflation,” “support costs,” and “infrastructure costs” may be 0.400, 0.099, 0.022, 0.041, 0.236, and 0.202, respectively (totaling to 1.000). The weights assigned to the criteria may be linear or non-linear. In the discussed example, weights for the sub-criteria under “Cost” are non-linear. The weights may also follow various curves, such as exponential or geometric curves.

Further, the selection of the weights for the criteria and/or for the measurement scales may be an iterative process. An initial set of weights for the criteria and/or for the measurement scales may be calculated, analyzed, and subsequently modified. The analysis may comprise analyzing the weights for the criteria and/or for the measurement scales themselves. Or, the analysis may comprise executing the AHP analysis, and examining the results. For example, the operator or management may examine the results of the AHP analysis to determine whether one or more criteria are under- or over-represented in the analysis, in effect skewing the results. The weights for the criteria and/or for the measurement scales may be subsequently modified based on the analysis. Iteration may be performed once or multiple times. FIG. 1 shows the iterative process via an arrow in Phase 2 of the detailed analysis.

Once the weights for the criteria and the measurement scales are finalized, the AHP analysis may be performed. A final list of contenders may be identified, as shown at block 170. The final contenders may include the top 5 locations, or may include any location that receives above a predetermined score. A final site recommendation may be made, as shown at block 180. The final site recommendation may be based on the final contenders generated in block 170.

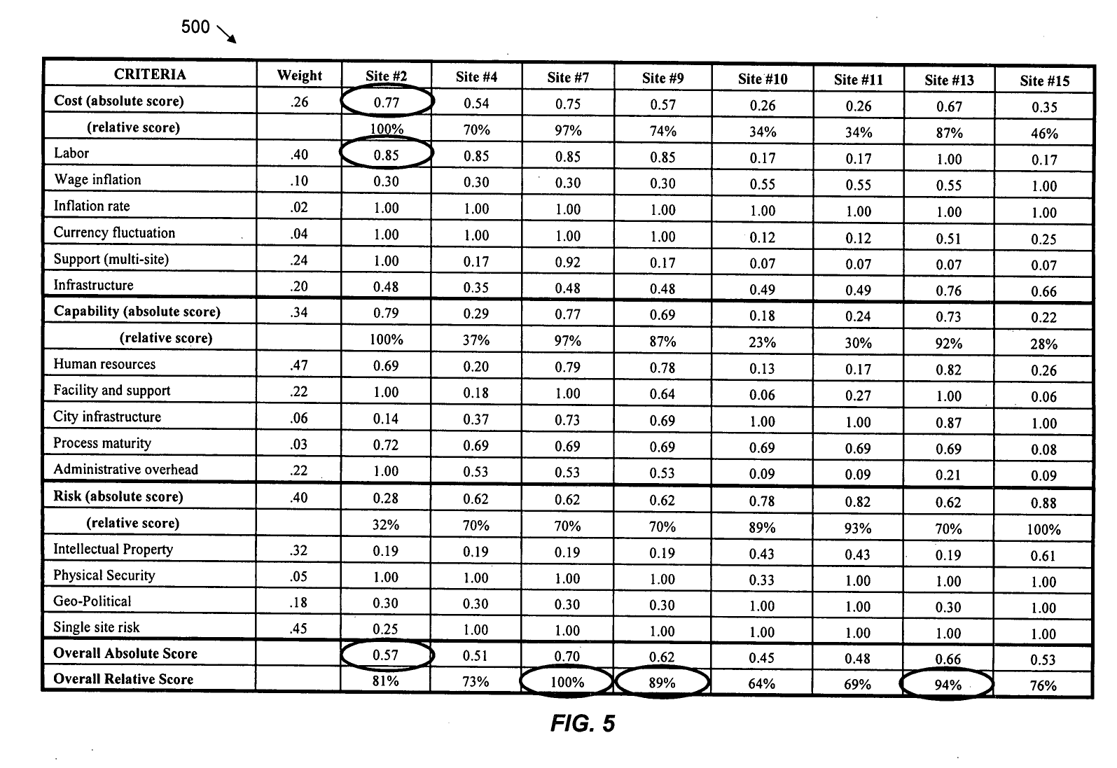

FIG. 5 shows a table 500 of criteria, weights, and calculated values for the shortlist of potential sites identified in block 120 of FIG. 1. Specifically, FIG. 5 lists the criteria depicted in FIG. 3 and weights for the criteria shown in FIG. 4. Further, the scores for the various criteria are shown for the potential sites. For example, the column labeled “site #2” indicates the scores for the various criteria. The score for labor cost is 0.85 (circled in FIG. 5), which indicates a normalized value between 0 and 1.00, how well site #2 rates for the cost of labor. Though, the scores need not be normalized.

As another example, the score for the cost criterion is 0.77 (circled in FIG. 5), which is based on the costs for the various sub-criteria. Specifically, the scores for the sub-criteria “labor cost,” “wage inflation,” “inflation rate,” “currency inflation,” “support costs,” and “infrastructure costs” are 0.85, 0.30, 1.00, 1.00, 1.00, and 0.48, respectively. These scores are weighted, using the weights of 0.40, 0.10, 0.02, 0.04, 0.24, and 0.20, respectively, to determine the overall score of 0.77 for cost. The scores for any one of the criteria may be compared with one another to determine the relative score (shown in FIG. 5). For example, the score for the cost criterion of site #2 may be compared with the scores for other sites to derive relative score. As shown in FIG. 5, site #2 has the highest score, and is rated at 100%. The remaining scores may be divided by the highest score to determine the relative score. For example, the relative score for site #4 may be determined by dividing 0.54 by 0.77.

Further, the overall absolute score may be determined by weighting the absolute scores for the cost, capability, and risk criteria. For example, the overall absolute score for site #2 may be determined by weighting 0.77 for cost, 0.79 for capability, and 0.28 for risk, with the corresponding weights of 0.26, 0.34, and 0.40. An overall relative score may be calculated by comparing the overall absolute scores for the sites with one another to derive an overall relative score. As shown in FIG. 5, site #7 has the highest overall absolute score, followed by site #13, site #9, etc.

Finally, FIG. 5 may be used in a variety of ways. For example, FIG. 5 may be used to analyze, and potentially modify the weights for the criteria and/or for the measurement scales. Specifically, the results depicted in FIG. 5 may be used to modify one, some, or all of the weights for the criteria and/or for the measurement scales. The modification(s) may be made, and the AHP analysis may be re-run, thereby showing the effect of changing the weights. Or, FIG. 5 may be used to identify the final contenders discussed in block 170 of FIG. 1.

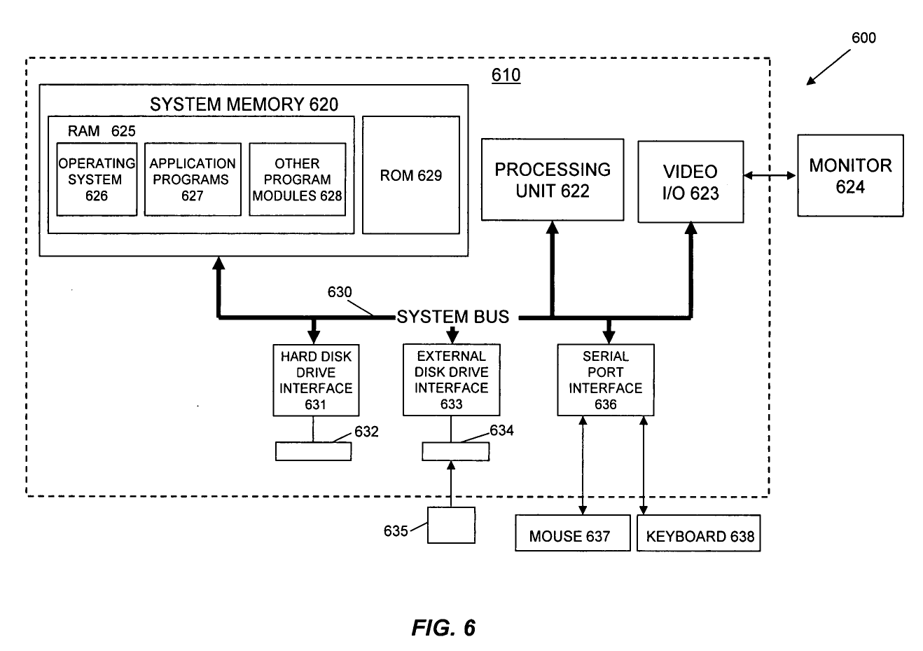

To perform AHP, a processing system 600, shown in block diagram form in FIG. 6, may be used. The processing system 600 may comprise a general purpose computing device 610, including a processing unit 622, a system memory 620, and a system bus 630, that couples various system components including the system memory 620 to the processing unit 622. The processing unit 622 may perform arithmetic, logic and/or control operations by accessing system memory 620. The system memory 620 may store information and/or instructions for use in combination with processing unit 622. The system memory 620 may include volatile and non-volatile memory, such as random access memory (RAM) 625 and read only memory (ROM) 629. A basic input/output system (BIOS) containing the basic routines that helps to transfer information between elements within the computer environment 610, such as during start-up, may be stored in ROM 629. The system bus 630 may be any of several types of bus structures including a memory bus or memory controller, a peripheral bus, and a local bus using any of a variety of bus architectures.

The computing environment 610 may further include a hard disk drive 632 for reading from and writing to a hard disk (not shown), and an external disk drive 634 for reading from or writing to a removable external disk 635. The removable disk may be a magnetic disk for a magnetic disk driver or an optical disk such as a CD ROM for an optical disk drive. The hard disk drive 632 and external disk drive 635 may be connected to the system bus 630 by a hard disk drive interface 631 and an external disk drive interface 633, respectively. The drives and their associated computer-readable media provide nonvolatile storage of computer readable instructions, data structures, program modules and other data for the computing environment 610. Although the exemplary environment described herein employs a hard disk and an external disk 635, it should be appreciated by those skilled in the art that other types of computer readable media which can store data that is accessible by a computer, such as magnetic cassettes, flash memory cards, random access memories, read only memories, and the like, may also be used in the exemplary operating environment.

A number of program modules may be stored on the hard disk, external disk 635, ROM 629 or RAM 625, including one or more application programs 627, other program modules (not shown), an operating system 626, and program data (not shown). One such application program may comprise AHP and include the functionality as detailed in blocks 160 and 170 in FIG. 1.

A user may enter commands and/or information, into computing environment 610 through input devices such as mouse 637 and keyboard 638. Other input devices (not shown) may include a microphone (or other sensors), joystick, game pad, scanner, or the like. These and other input devices may be connected to the processing unit 622 through a serial port interface 636 that is coupled to the system bus 630, or may be collected by other interfaces. A monitor 624, or other type of display device, may also be connected to the system bus 630 via an interface, such as a video input/output 623. In addition to the monitor 624, computing environment 610 may include other peripheral output devices (not shown), such as speakers or other audible output.

While this invention has been shown and described in connection with the preferred embodiments, it is apparent that certain changes and modifications in addition to those mentioned above may be made from the basic features of this invention. In addition, there are many different types of computer software and hardware that may be utilized in practicing the invention, and the invention is not limited to the examples described above. The invention was described with reference to acts and symbolic representations of operations that are performed by one or more electronic devices. As such, it will be understood that such acts and operations include the manipulation by the processing unit of the electronic device of electrical signals representing data in a structured form. This manipulation transforms the data or maintains it at locations in the memory system of the electronic device, which reconfigures or otherwise alters the operation of the electronic device in a manner well understood by those skilled in the art. The data structures where data is maintained are physical locations of the memory that have particular properties defined by the format of the data. While the invention is described in the foregoing context, it is not meant to be limiting, as those of skill in the art will appreciate that the acts and operations described may also be implemented in hardware. Accordingly, it is the intention of the Applicants to protect all variations and modification within the valid scope of the present invention. It is intended that the invention be defined by the following claims, including all equivalents.

1. An outsourcing location assessment system for assessing locations for outsourcing comprising:
an analytical hierarchy process model comprising:
a cost criterion,
a capability criterion, and
a risk criterion,
a user interface adapted to receive input regarding importance of each criterion relative to other criteria, and data regarding cost, capability, and risk for the locations; and
an analytical hierarchical process engine operatively associated with the user interface and the analytical hierarchy model, and adapted to:
analyze the input to determine weights for the cost, capability, and risk criteria, and
rank at least some of the plurality of locations based on the weights, criteria, and data.

2. The system of claim 1, wherein the cost criterion comprises:
a plurality of sub-criteria of the cost criterion, the plurality of sub-criteria comprising at least one of:
a labor cost sub-criterion;
a wage inflation sub-criterion;
an inflation rate sub-criterion;
a currency inflation sub-criterion;
a support cost sub-criterion; and
an infrastructure cost sub-criterion.

3. The system of claim 2, wherein the infrastructure cost sub-criterion comprises a fixed cost sub-sub-criterion and an on-going cost sub-sub-criterion.

4. The system of claim 1, wherein the capability criterion comprises:
a plurality of sub-criteria of the capability criterion, the plurality of sub-criteria comprising at least one of:
a city infrastructure sub-criterion;
a process maturity sub-criterion;
a human resources sub-criterion; and
a facilities and support sub-criterion.

5. The system of claim 4, wherein the city infrastructure sub-criterion comprises a current sub-sub-criterion and a future sub-sub-criterion.

6. The system of claim 1, wherein the risk criterion comprises:
a plurality of sub-criteria of the risk criterion, the plurality of sub-criteria comprising at least one of:
an intellectual property sub-criterion;
a physical security sub-criterion;
a geo-political stability sub-criterion; and
a single site risk sub-criterion.

7. The system of claim 1, wherein the user interface receives comparison of at least one criterion relative to other criteria.

8. The system of claim 1, wherein the comparison comprises comparing each criterion relative to each other criterion.

9. The system of claim 1, wherein analyzing the input to determine weights comprises pair-wise comparisons.

10. The system of claim 1, wherein the analytical hierarchy process model comprises a multi-level hierarchy, with at least a bottom level and a top level.

11. The system of claim 10, wherein the analytical hierarchical process engine determines the weights from the bottom level upward to the top level.

12. The system of claim 10, wherein the analytical hierarchical process engine determines the weights from the top level downward to the bottom level.

13. The system of claim 1, wherein the data regarding cost, capability, and risk comprises raw data and measurement scales.

14. The system of claim 13, wherein the measurement scales include weights.

15. The system of claim 14, wherein the analytical hierarchical process engine iteratively ranks at least some of the plurality of locations based on changes to the weights.

16. The system of claim 14, wherein the weights are non-linear.

17. The system of claim 1, wherein the analytical hierarchical process engine iteratively ranks at least some of the plurality of locations.

18. The system of claim 17, wherein the iterative ranking is based on changes to weights for at least one of the cost, capability, and risk criteria.

19. A method for assessing potential outsourcing locations, the method comprising:
providing an analytical hierarchy process model comprising a cost criterion, a capability criterion, and a risk criterion;
receiving input, via a user interface, regarding importance of each criterion relative to other criteria, and data regarding cost, capability, and risk for the locations; and
analyzing the received input, using an analytical hierarchical process engine, by determining weights for the cost, capability, and risk criteria and by ranking at least some of the plurality of locations based on the weights, criteria, and data.

20. The method of claim 19, wherein analyzing the input to determine weights comprises performing pair-wise comparisons.

21. The method of claim 19, wherein analyzing comprises iteratively ranking at least some of the plurality of locations.

22. The method of claim 21, wherein interatively ranking is based on changes to weights for at least one of the cost, capability, and risk criteria.
